(19) United States
(12) Patent Application Publication
(10) Pub. No.: US 2010/0140477 A1
(43) Pub. Date: Jun. 10, 2010

(54) METHOD AND DEVICE FOR GAS ANALYSIS

(76) Inventors: Alexander Graf, Friedrichshafen (DE); Holger Mielenz, Ostfildern (DE)

Correspondence Address: KENYON & KENYON LLP, ONE BROADWAY, NEW YORK, NY, 10004, US

(21) Appl. No.: 12/451,035

(22) PCT Filed: May 9, 2008
(86) PCT No.: PCT/EP2008/055768

§ 371 Date: Feb. 18, 2010

(30) Foreign Application Priority Data
May 24, 2007 (DE) 10 2007 024 198.6

(51) Int. Cl. G01N 21/35; G01J 5/02; G06F 19/00

(52) U.S. Cl. 250/339.07; 73/23.2; 702/24

(57) ABSTRACT

A method for determining at least one gas variable by way of a gas sensor system, and at least one system variable of that gas sensor system, in which:—the gas variable is measured at least twice, the at least two measurements differing because two different values are set for a parameter of the gas sensor system, and—based on the at least two measurements, the at least one system variable and the at least one gas variable are determined.

### BACKGROUND OF THE INVENTION

1. Field of the Invention

The invention relates generally to a method and apparatus for gas analysis.

2. Description of Related Art

Gas measurement technology is a common application for spectroscopic sensors. The functional principle is based on the Beer-Lambert absorption law, according to which gases absorb infrared (IR) radiation in specific wavelength regions as a result of the excitation of molecular vibrations. The number of interactions between photons and molecules governs the degree of radiation absorption. The measured intensity therefore allows a direct inference as to the number of molecules in the absorption path. A variety of elements can be used as IR sources and IR detectors. In the medium IR region, for example, in which the absorption bands of gases are particularly pronounced, thermal radiators such as incandescent lamps or microelectromechanical systems (MEMS) can be used. Bolometers, pyroelectric detectors, and thermopiles are known as corresponding detector elements. During operation, the radiation source in particular is subject to a variety of drift effects. In gas detectors, for example, if the radiation intensity is measured using only one detector, drift effects are directly incorporated as an error into the calculation of the number of molecules. Two different methods are presently known for reducing such a deviation:

1) Reference using an additional detector element:
Using a second infrared detector arranged in one reference channel, the radiation intensity of the IR emitter is measured in an atmospheric window. In this wavelength region it is possible to sense the instantaneously emitted intensity of the radiation source uninfluenced by absorption effects. Because the Beer-Lambert absorption law has a multiplicative correlation between gas concentration and IR intensity, drift effects of the IR radiator can be minimized by taking the quotient of the absorption measurement and reference measurement.

2) Reference using an additional IR radiator:
In contrast to the concept just described, a second IR radiator is used as a reference. This is intended to compensate for intensity fluctuations that are brought about, especially with thermal emitters, by mechanical damage caused by shocks while in the hot state. The systematic approach with this concept is to use one radiator continuously to measure the gas concentration. The second radiator, used as a reference radiator, is switched on briefly at widely spaced intervals in order to normalize the measured concentration value to its target value. It is assumed in this context that the reference radiator always generates the correct output signal.

### SUMMARY OF THE INVENTION

The invention is a method for determining at least one gas variable by way of a gas sensor system, and at least one system variable of that gas sensor system, in which:
the gas variable is measured at least twice, these at least two measurements differing because two different values are set for a parameter of the gas sensor system, and
based on the at least two measurements, the at least one system variable and the at least one gas variable can be determined.

The invention makes it possible to sense, simultaneously with the measurement of gas variables, additional system variables that can be used, for example, for a calibration of the system.

An advantageous embodiment of the invention is characterized in that the parameter is the temperature of a radiation source associated with the gas sensor. This parameter is particularly easy to set.

An advantageous embodiment of the invention is characterized in that the gas variable is a gas concentration.

An advantageous embodiment of the invention is characterized in that the system variable is a variable describing the aging or the remaining service life of the radiation source.

An advantageous embodiment of the invention is characterized in that the system variable is a variable characterizing contamination of the gas sensor system.

An advantageous embodiment of the invention is characterized in that the gas sensor system is a spectroscopic gas sensor system.

An advantageous embodiment of the invention is characterized in that what is generated by the at least two measurements is a linear equation system
the number of whose equations corresponds to the number of measurements, and
the unknowns of which are the gas variables and the system variables,
the determining of the gas variables and the system variables being accomplished by solving the linear equation system.

Linear equation systems can easily be solved using known standard mathematical methods. A pattern recognition algorithm can also be used for that purpose.

The invention further encompasses an apparatus for determining at least one gas variable by way of a gas sensor system, and at least one system variable of that gas sensor system, containing
means for measuring the gas variable at least twice, the at least two measurements differing by the fact that two different values are set for a parameter of the gas sensor system, and
means for determining the at least one system variable and the at least one gas variable from the at least two measurements.

An advantageous embodiment of the invention is characterized in that the gas sensor system is a spectroscopic gas sensor system made up of
a radiation source,
an optical absorption section, and
a radiation detector.

### BRIEF DESCRIPTION OF THE DRAWINGS

FIG. 1 shows a conventional gas analysis system.

FIG. 2 shows a nonspecific or nonselective IR filter transmissivity characteristic.

FIG. 3 shows a specific or selective IR filter transmissivity characteristic.

FIG. 4 shows a characteristic intensity profile of a beam in constant-current operating mode as an incandescent filament becomes thinner.

FIG. 5 shows a characteristic intensity profile in the context of a contaminated beam path.

FIG. 6 shows execution of the method according to the present invention.

### DETAILED DESCRIPTION OF THE INVENTION

The object of the invention is to correct the deviations of a sensor system, but without needing to integrate additional hardware components such as a detector or IR source. The invention relates in particular to spectroscopic sensors. In the case of thermal radiation sources, additional linearly independent information regarding the state of the sensor system is to be obtained by measuring at two different IR radiator temperatures. On the basis of these data it is possible to correct deviations. Advantageously, additional hardware such as, for example, a reference channel can be omitted, since it is sufficient to adapt the control software in such a way that measurements can be made, with a small offset in time, at two different radiator temperatures. The invention further allows the state of the sensor system to be observed continuously. This yields the possibility for autonomous calibration of the system, and for investigations of remaining service life or end-of-life calculations for critical components.

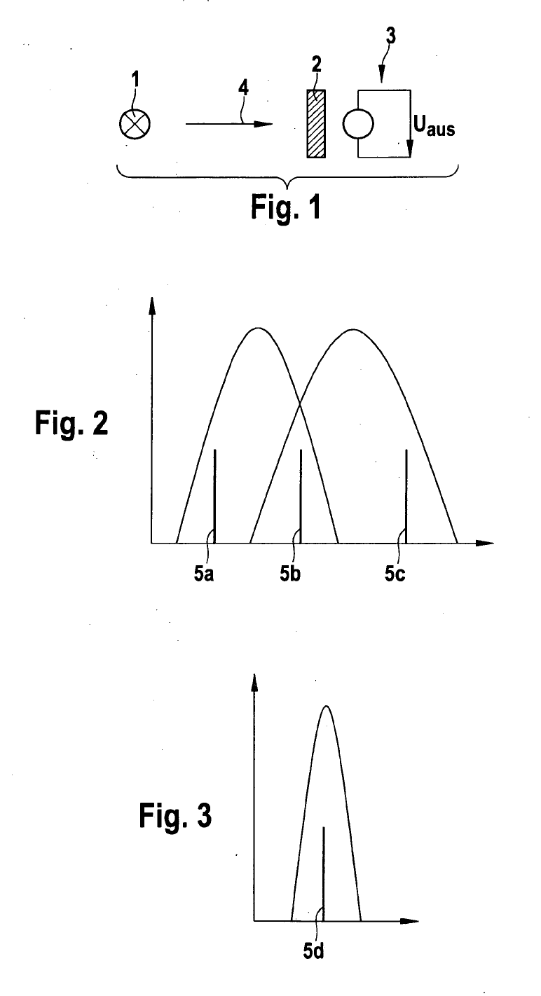

The basis of the system is a conventional optical sensor system as depicted in FIG. 1. This system has a radiator 1, an optical absorption path 4, and one or more wavelength-selective elements 2 with a detector 3 located behind them. Transmission filters, whose transmissivity characteristic can be both selective (as depicted in FIG. 3 by absorption line 5d) and nonspecific (as depicted in FIG. 2 by absorption lines 5a to 5c), can also be used in particular as wavelength-selective elements 2. With respect thereto, in FIGS. 2 and 3 a frequency is plotted on the abscissa and the transmissivity on the ordinate.

In order to allow calculation, in the case of a gas sensor, of the concentration of one or more gases of a mixture, a linearly independent measurement point must be present for each absorption line. In the simplest case, as depicted in FIG. 3, this can be achieved by way of a single measurement point.

In the case of the two-channel system depicted in FIG. 2, it is already necessary to arrive at two linearly independent working points. This can be achieved, for example, by modifying the filament temperature of a thermal radiator such as, for example, an incandescent bulb. A total of four linearly independent measurement points are generated in this fashion by measuring two detectors (one detector per channel) each at two different temperatures. For three unknowns (these being the three gases, relevant to the three absorption lines 5a, 5b, and 5c, whose concentration is to be measured), a corresponding linear equation system would be redundant. The additional linearly independent datum is available for the observation of system-relevant parameters.

In analytical terms, for a known concentration of the gases, an allocation of the detector voltage to the intensity of the radiation source can be created by way of the additional linearly independent measured value. With continuous observation of the system it is thus possible to detect characteristic deviation profiles and to institute countermeasures. Countermeasures are, for example, a correction of a measured value or a warning function in the case of an expected defect.

Even in the simpler case of FIG. 3, by measuring at a second working point it is possible to obtain additional linearly independent information about the system and use it for self-calibration, with the result that here as well, additional reference channels can be dispensed with.

Two characteristic defects, among others, can be detected as follows:

1) Defect in the radiation source:
It may be expected according to Ohm's law that, for example, the intensity of the filament will rise during constant-current operation as the filament becomes thinner. The diagnosis function would produce a curve similar to FIG. 4, in which the operating time t is plotted on the abscissa and the emitted intensity I on the ordinate. The emitted intensity I rises with operating time t.

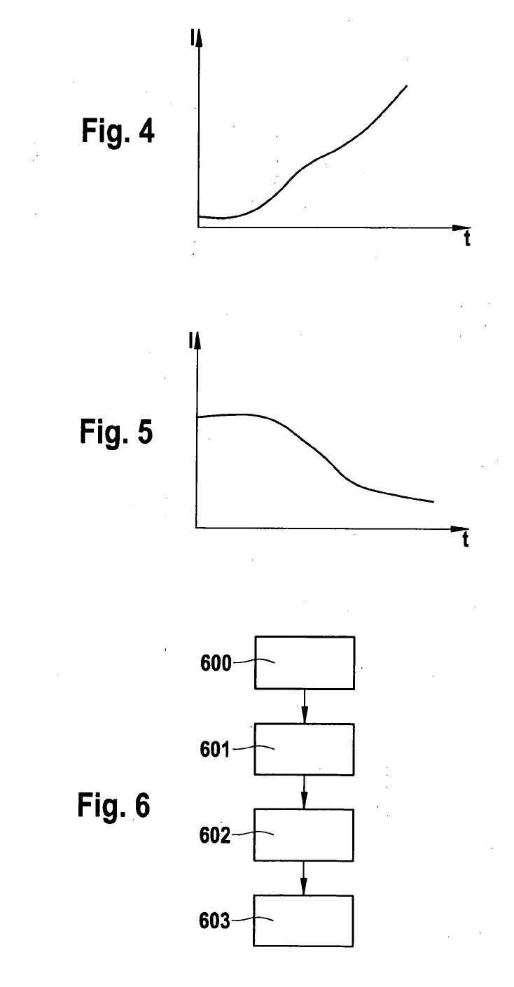

2) Contamination of the optical path:
A reduction in the measured intensity may be expected when, for example, dust or other deposits have settled onto filters or reflective elements. FIG. 5 depicts a characteristic intensity curve for a beam path that becomes increasingly contaminated over time. Here the time t is depicted on the abscissa, and the ordinate represents an intensity I sensed with a detector element or arriving at the detector element.

The characteristic profiles allow different types of defect to be detected, and calculations of remaining service life to be made. The result is that, for example, the remaining service life of an incandescent bulb can be predefined more exactly. The data profiles can be evaluated, for example, analytically by adaptation of the measured data, or by the use of methods such as regression procedures or neural networks.

Execution of the method according to the present invention is depicted in FIG. 6. After the method starts in block 600, the gas variable is measured at least twice in block 601, the at least two measurements being different because two different values have been set for a parameter of the gas sensor system. Then in block 602, based on the at least two measurements, the at least one system variable and the at least one gas variable are determined. The method according to the present invention ends in block 603.

1-10. (canceled)

11. A method for determining at least one gas variable by way of a gas sensor system, and at least one system variable of that gas sensor system, comprising:
measuring a gas variable at least twice so as to obtain at least two different measurements because two different values are set for a parameter of the gas sensor system, and
determining at least one system variable and at least one gas variable based on the at least two measurements.

12. The method as recited in claim 11, wherein the parameter is the temperature of a radiation source associated with the gas sensor.

13. The method as recited in claim 11, wherein the gas variable is a gas concentration.

14. The method as recited in claim 12, wherein the system variable is a variable describing the aging or the remaining service life of the radiation source.

15. The method as recited in claim 11, wherein the system variable is a variable characterizing contamination of the gas sensor system.

16. The method as recited in claim 11, wherein the gas sensor system is a spectroscopic gas sensor system.

17. The method as recited in claim 11, wherein a linear equation system is generated by the at least two measurements, and wherein:
the number of equations of the linear equation system corresponds to the number of measurements,
the unknowns of the linear equation system are the gas variables and the system variables, and
the determining of the gas variables and the system variables is accomplished by solving the linear equation system.

18. The method as recited in claim 17, wherein the equation is solved using a pattern recognition algorithm.

19. An apparatus for determining at least one gas variable by way of a gas sensor system, and at least one system variable of that gas sensor system, comprising:
means for measuring the gas variable at least twice so as to obtain at least two measurements differing by the fact that two different values are set for a parameter of the gas sensor system, and
means for determining the at least one system variable and the at least one gas variable from the at least two measurements.

20. The apparatus as recited in claim 19, wherein the gas sensor system is a spectroscopic gas sensor which includes:
a radiation source,
an optical absorption section, and
a radiation detector.
